(19) United States
(12) Patent Application Publication
(10) Pub. No.: US 2023/0103796 A1
(43) Pub. Date: Apr. 6, 2023

(54) EVENT-BASED TRIGGERS OF CRYPTOCURRENCY TRANSACTIONS

(71) Applicant: PAYPAL, INC., San Jose, CA (US)

(72) Inventor: Sujay Vijay Purandare, Portland, OR (US)

(21) Appl. No.: 17/493,529

(22) Filed: Oct. 4, 2021

(51) Int. Cl. G06Q 20/36; G06Q 30/04; G06Q 20/38; G06Q 40/02; H04L 9/32

(52) U.S. Cl. CPC G06Q 20/3678; G06Q 30/04; G06Q 20/3827; G06Q 40/02; H04L 9/3239; H04L 2209/56

(57) ABSTRACT

Methods and systems are presented for providing a framework for facilitating event-based triggers of auxiliary cryptocurrency transactions via a Layer 2 cryptocurrency computer network. A transaction system detects a triggering event associated with a first digital wallet. Based on the detected event, the transaction system determines an auxiliary cryptocurrency transaction for the first digital wallet. Without recording the auxiliary cryptocurrency transaction in a public ledger associated with the cryptocurrency, the transaction system conducts the auxiliary cryptocurrency transaction via the Layer 2 cryptocurrency computer network via one or more payment channels established by computer nodes in the Layer 2 cryptocurrency computer network.

### BACKGROUND

The present specification generally relates to electronic cryptocurrency transactions, and more specifically, to providing a computer framework for facilitating event-based triggers of cryptocurrency transactions according to various embodiments of the disclosure.

### RELATED ART

As an increasing number of merchants are accepting cryptocurrency as a payment instrument, cryptocurrency is becoming more popular among the public. For example, many people can now use cryptocurrency to purchase goods and services from numerous merchants. However, due to the technical requirements of processing transactions using cryptocurrency, there remains several disadvantages when transacting using cryptocurrency. For example, it takes a large amount of computer resources to complete a cryptocurrency transaction due to the proof-of-work or proof-of-stake requirements. Thus, a substantial amount of computer resources is consumed for the transaction, and the time required for processing cryptocurrency transactions can be long (which may take several minutes or even hours). Furthermore, due to the service fees charged by processing computer nodes for processing cryptocurrency transactions, transacting using cryptocurrency may not be justifiable unless the transaction amount is sufficiently large (e.g., above a threshold). This may prevent use of cryptocurrency transactions for desired transactions easily handled through conventional funding, such as automatic recurring payments. As such, it is challenging to implement many auxiliary services associated with cryptocurrency transactions, such as event-based triggers of cryptocurrency transactions. Thus, there is a need for providing a framework for facilitating event-based triggers of cryptocurrency transactions.

### BRIEF DESCRIPTION OF THE FIGURES

FIG. 1 is a block diagram illustrating a networked system that includes an electronic transaction system according to an embodiment of the present disclosure;

FIG. 2 is a block diagram illustrating a transaction module according to an embodiment of the present disclosure;

FIG. 3 illustrates an example Layer 2 cryptocurrency computer network according to an embodiment of the present disclosure;

FIG. 4 illustrates a payment channel established between two computer nodes in a Layer 2 cryptocurrency computer network according to an embodiment of the present disclosure;

FIG. 5 illustrates an example data flow associated with conducting an auxiliary cryptocurrency transaction according to an embodiment of the present disclosure;

FIG. 6 is a flowchart showing a process of conducting an auxiliary cryptocurrency transaction according to an embodiment of the present disclosure; and

FIG. 7 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure includes methods and systems for providing a framework for facilitating event-based triggers of cryptocurrency transactions via a Layer 2 cryptocurrency computer network. As discussed above, performing electronic transactions using cryptocurrency has several disadvantages, which prevents certain services to be efficiently provided to users of cryptocurrency. One such service is automatic triggering of cryptocurrency transactions based on detected events, also referred to herein as auxiliary cryptocurrency transactions. An auxiliary cryptocurrency transaction is a cryptocurrency transaction that is not directly initiated by a user, but instead, automatically triggered by an event. The event may include a time event (e.g., a particular day of the week, a particular day of the month, etc.), a payment event, such as a payment transaction using a fiat currency and/or a cryptocurrency, and/or other events that are defined by the user. The auxiliary cryptocurrency transactions usually involve a small amount (e.g., below a threshold amount such as an equivalent of USD $1, USD $0.1, etc.) and are performed frequently (e.g., several times in a week, etc.) in order to achieve a goal or meet obligations defined by the user.

For example, the user may define a goal of paying off a loan or saving money toward a future purchase. In order to achieve the goal, it is desirable for the user to set up automatic transfers of funds in cryptocurrency (e.g., auxiliary cryptocurrency transactions) from a digital wallet of the user to a different digital wallet (e.g., another digital wallet of the user such as one associated with a savings account of the user, a digital wallet of an entity associated with the loan, etc.) based on a detectable event. When the event is detected (e.g., reaching a current time or day corresponding to the predetermined time or day, detecting a transaction being conducted through the digital wallet of the user or another funding account, etc.), an amount of cryptocurrency may be transferred from the digital wallet of the user to the other digital wallet.

However, as discussed herein, conducting frequent cryptocurrency transactions, especially when the transaction amounts are small, can be inefficient and challenging. Traditionally, cryptocurrency transactions are conducted based on recording transaction data in a decentralized and distributed ledger (e.g., a blockchain). Copies of the ledger are stored in a distributed manner across multiple computers in a cryptocurrency network (also referred to as a “Layer 1 cryptocurrency computer network”). When a new transaction is broadcasted, multiple computer nodes within the Layer 1 cryptocurrency computer network may compete against each other to process the new transaction by performing a required proof-of-work or proof-of-stake routine, which consumes a substantial amount of computer processing resources. The one computer node that has completed the required routine the fastest would record the transaction on the ledger and receive a compensation (e.g., a mined coin and/or a service fee, etc.). Since each cryptocurrency transaction requires substantial computer processing resources across the Layer 1 cryptocurrency computer network, the frequently conducted auxiliary cryptocurrency transactions can consume a large amount of the computer resources within the Layer 1 cryptocurrency computer network, which may affect the overall processing time for the computer network to process cryptocurrency transactions. Furthermore, the service fee charged by the computer nodes within the computer network for processing the auxiliary cryptocurrency transactions (usually in small amounts) may render the auxiliary cryptocurrency transactions financially unjustifiable for the user (e.g., when the service fee exceeds the amount being transacted in the auxiliary cryptocurrency transactions).

Thus, accordingly to various embodiments of the disclosure, a transaction system is configured to facilitate auxiliary cryptocurrency transactions using a Layer 2 cryptocurrency computer network. The Layer 2 cryptocurrency computer network is a separate computer network from the Layer 1 cryptocurrency computer network. A computer node may participate in the Layer 2 cryptocurrency computer network by establishing a payment channel with another computer node. A payment channel includes a multi-signature agreement recorded in the Layer 1 cryptocurrency computer network where any transaction using funds from the payment channel in the Layer 1 cryptocurrency computer network requires digital signature from the two parties (e.g., the two computer nodes) associated with the payment channel. At least one of the two participating computer nodes may contribute funds (in cryptocurrency) to the payment channel to prove its liquidity for transacting within the Layer 2 cryptocurrency computer network.

Once a payment channel is established between the two computer nodes, the two computer nodes can perform cryptocurrency transactions (transferring funds between the two computer nodes) outside of the Layer 1 cryptocurrency computer network (e.g., off-chain transactions). Initially, each of the two computer nodes is assigned with the amount of cryptocurrency that the computer node contributed in the payment channel. Each transaction from a computer node may use at least a portion of the funds assigned to the computer node in the payment channel, as long as the total transaction amount including all previous Layer 2 transactions by the computer node does not exceed the amount assigned to the computer node. Each transaction is conducted by issuing a new agreement between the two computer nodes for reassigning (e.g., reallocating) the funds within the payment channel based on the amount in the transaction and the previous assignment of the funds, without recording the transaction within the Layer 1 cryptocurrency computer network. The new agreement would supersede any previous agreement between the two computer nodes. As such, no computer resources associated with the proof of work or proof of stake requirements are consumed throughout the cryptocurrency transaction. Only when a payment channel is terminated would a transaction for settling the funds allocation between the two computer nodes need to be recorded in the Layer 1 cryptocurrency computer network. Thus, transactions conducted via the Layer 2 cryptocurrency computer network require less computer resources and less time than the same transactions conducted via the Layer 1 cryptocurrency computer network.

The two computer nodes may in turn establish additional payment channels with other computer nodes in a similar manner to further extend the Layer 2 cryptocurrency computer network. Thus, after multiple payment channels are established among the computer nodes within the Layer 2 cryptocurrency computer network, one computer node may conduct Layer 2 cryptocurrency transactions with another computer node as long as the two computer nodes are connected via one or more payment channels (even though no payment channel is established between the two computer nodes).

In some embodiments, the transaction system may perform auxiliary cryptocurrency transactions for a digital wallet of a user using the Layer 2 cryptocurrency computer network based on techniques disclosed herein. In some embodiments, the transaction system may enable the user to configure the parameters of the auxiliary cryptocurrency transactions (e.g., via a user interface provided to the user). The transaction system may receive inputs from the user that specify one or more events, such as a particular time of day, a particular day of week (or day of month), a transaction using a digital wallet of the user, and/or any other detectable events. The transaction system may also receive inputs from the user that specify parameters of the auxiliary cryptocurrency transactions such as an identity of a recipient digital wallet and a transaction amount (e.g., a fixed amount, a dynamic amount determined based on the corresponding transaction, etc.).

The transaction system may determine whether an existing digital wallet of the user can be used to conduct Layer 2 cryptocurrency transactions. If the existing digital wallet cannot be used to conduct Layer 2 cryptocurrency transactions, the transaction system may create a new digital wallet for the user that can be used to conduct Layer 2 cryptocurrency transactions. In some embodiments, the transaction system may create the new digital wallet for the user based on configurations associated with the existing digital wallet (e.g., a name, contact information such as email address, credentials, linked financial account such as a band account, etc.). The transaction system may link the two digital wallets to the user.

The transaction system may store the event-based trigger configuration in a data storage associated with a transaction account of the user. After configuring the event-based trigger(s) for the transaction account of the user, the transaction system may begin monitoring events associated with the transaction account based on the event-based trigger configuration. For example, where the event is a time event, the transaction system may detect whether a current time or a current day corresponds to a time event in the event-based trigger configuration. In another example where the event is associated with another transaction using the digital wallet (or another funding account), the transaction system may monitor transactions being conducted using the digital wallet (or the other funding account).

When an event is detected (e.g., a current time corresponds to a specified time, a transaction is being conducted using the digital wallet, etc.), the transaction system may conduct, through the digital wallet of the user, an auxiliary cryptocurrency transaction using the Layer 2 cryptocurrency computer network based on the event-based trigger configuration of the transaction account. In some embodiments, the transaction system may first determine parameters associated with the auxiliary cryptocurrency transaction based on the event-based trigger configuration. The parameters may include an identity of a recipient digital wallet. The recipient digital wallet may be a digital wallet associated with a third-party entity (e.g., a bank, a loan company, a merchant, another person's digital wallet, etc.) or a second digital wallet associated with the user (e.g., for saving purposes). The transaction system may then determine a route that includes one or more computer nodes connected via one or more payment channels within the Layer 2 cryptocurrency computer network for conducting the auxiliary cryptocurrency transaction. In some embodiments, the transaction system may determine a first computer node within the Layer 2 cryptocurrency computer network that is associated with the digital wallet of the user. The first computer node is associated with the digital wallet when the first computer node can be used to conduct cryptocurrency transactions over the Layer 2 cryptocurrency computer network for the digital wallet.

The transaction system may also determine a second computer node within the Layer 2 cryptocurrency computer network that is associated with the recipient digital wallet. If the first computer node is directly connected to the second computer node (e.g., a single payment channel is established between the first computer node and the second computer node), the transaction system may determine the route from the digital wallet of the user and the recipient digital wallet via the single payment channel. On the other hand, if the first computer node is not directly connected to the second computer node (e.g., no payment channel is established between the first computer node and the second computer node), the transaction system may traverse the Layer 2 cryptocurrency computer network to determine if the first computer node and the second computer node are connected indirectly via one or more other computer nodes via one or more payment channels. When it is determined that the first computer node and the second computer node are connected within the Layer 2 cryptocurrency computer network, the transaction system may determine a route that connects the first computer node to the second computer node within the Layer 2 cryptocurrency computer network.

Since computer nodes within the Layer 2 cryptocurrency computer network may be connected via different paths, multiple routes may be determined that connect the first computer node to the second computer node. When multiple routes are identified, the transaction system may determine one route for conducting the auxiliary cryptocurrency transaction. In some embodiments, the transaction system may determine a route that includes the least number of computer nodes for conducting the auxiliary cryptocurrency transaction. In some embodiments, the transaction system may determine a route that involves the least amount of service charges required by the computer nodes along the route for conducting the auxiliary cryptocurrency transaction.

The transaction system may generate a request for invoice in the amount determined based on the event-based trigger configuration. For example, the amount may be a fixed amount specified in the event-based trigger configuration. In another example, the transaction system may determine the amount based on a transaction amount of a corresponding transaction that triggers the auxiliary cryptocurrency transaction. The transaction system may determine the amount for the auxiliary cryptocurrency transaction as a percentage of the transaction amount (e.g., 1%, 0.1%, etc.), as specified in the event-based trigger configuration. The transaction system may also include an identity of the digital wallet of the user (e.g., a wallet identifier, etc.) in the request for invoice, such that the invoice may be generated for the digital wallet. The transaction system may then transmit the request for invoice to the recipient digital wallet. The transaction system may transmit the request for invoice through the Layer 2 cryptocurrency computer network or through another network (e.g., the Internet).

Upon receiving the request for invoice, the recipient digital wallet may generate a digital invoice based on the amount included in the request for the digital wallet of the user. In some embodiments, the recipient digital wallet may also include a hashed value in the digital invoice, where the hashed value is generated by performing a hash operation on a secret (e.g., pre-image data). The recipient digital wallet may transmit the invoice including the hashed value to the digital wallet of the user via the Layer 2 cryptocurrency computer network.

The digital wallet of the user may receive the digital invoice generated by the recipient digital wallet. The transaction system may instruct the first computer node associated with the digital wallet to fund the digital invoice. The first computer node may fund the digital invoice by creating, for the invoice, a hash time lock contract (HTLC) between the first computer node and the next computer in the route. The hash time lock contract specifies a condition for release of funds from the first computer node to the next computer node upon a condition, which may be the receipt of the pre-image corresponding to the hashed value included in the invoice.

If the first computer node is directly connected to the second computer node via a payment channel established between the first and second computer nodes, the first computer node may transmit the HTLC to the second computer node. However, if the first computer node is not directly connected to the second computer node in the Layer 2 cryptocurrency computer network, the first computer node may transmit the HTLC to another computer node (e.g., a third computer node) along the route with which the first computer node is directly connected (e.g., a payment channel is established between the first computer node and the third computer node). The third computer node may similarly create an HTLC between the third computer node and the next computer node (e.g., a fourth computer node) along the route. The intermediate computer nodes may continue to create HTLCs with the next computer node until an HTLC is created between an intermediate computer node and the second computer node associated with the recipient digital wallet.

Based on receiving the HTLC, the recipient digital wallet may send a confirmation back to the digital wallet of the user. The confirmation may include the secret used by the recipient digital wallet to generate the hashed value. After receiving the confirmation, the transaction system may verify the confirmation by performing a hash operation on the secret to determine whether output from the hash operation corresponds to the hashed value from the digital invoice. By performing the auxiliary cryptocurrency transactions via the Layer 2 cryptocurrency computer network based on a detected event (which may include a corresponding transaction conducted via the Layer 1 cryptocurrency computer network), the transaction system improves the performance of processing the auxiliary transactions and reduce computer processing usage associated with the Layer 1 cryptocurrency computer network.

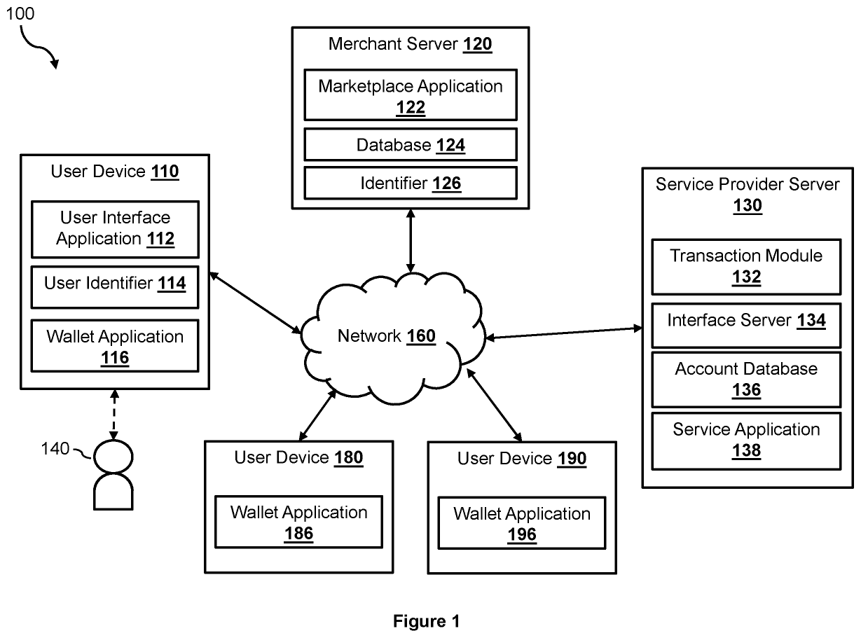

FIG. 1 illustrates a networked system 100, within which the transaction system may be implemented according to one embodiment of the disclosure. Note that the present techniques may be applied in many different computing and technological environments, however, and are not limited to those shown in the figures. The networked system 100 includes a service provider server 130, a merchant server 120, and user devices 110, 180 and 190 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online transaction with the merchant server 120 via websites hosted by, or mobile applications associated with, the merchant server 120. The user 140 may also log in to a user account to access account services or conduct electronic transactions (e.g., account transfers or payments, purchasing goods and/or services, etc.) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130, and/or the merchant server 120 via the network 160. In another implementation, the user interface application 112 includes a browser module that provides a network interface to browse information available over the network 160. For example, the user interface application 112 may be implemented, in part, as a web browser to view information available over the network 160.

The user device 110 may include a wallet application 116 configured to facilitate payments for the user 140. In some embodiments, the wallet application 116 may be associated with a digital wallet of the user 140 such that funds (e.g., in a fiat currency, in a cryptocurrency, etc.) can be transferred from the digital wallet of the user 140 to another digital wallet of another user (e.g., the wallet application 186 of the user device 180, the wallet application 196 of the user device 190, or other wallet application associated with another entity such as the merchant server 120, etc.) using the wallet application 116. In some embodiments, the wallet application 116 may be configured to perform cryptocurrency transactions. The user 140, through the user interface provided by the wallet application 116 on the user device 110, may initiate a cryptocurrency transaction (e.g., transferring a particular amount in a cryptocurrency from the digital wallet of the user 140 to another digital wallet). For example, the user 140 may specify an identity of the recipient digital wallet and an amount in the cryptocurrency via the user interface of the wallet application 116. The wallet application 116 may broadcast transaction data associated with the cryptocurrency transaction over a Layer 1 cryptocurrency computer network.

As discussed herein, the Layer 1 cryptocurrency computer network includes multiple computer nodes for managing a decentralized and distributed ledger (e.g., a blockchain) that stores transactions associated with the cryptocurrency. Each computer node within the Layer 1 cryptocurrency computer network manages a copy of the ledger. When the computer nodes receive the transaction data associated with the transaction from the digital wallet 116, the computer nodes compete against each other in solving a mathematical problem (which is part of the proof-of-work or proof-of-stake requirement). Once a computer node solves the mathematical problem, the computer node may record the transaction (e.g., in a block) and broadcast the block and the solution to the mathematical problem to the other computer nodes, such that the other computer nodes can update their copies of the ledger. The computer node that won (e.g., the fastest to solve the mathematical problem) would be granted the right to receive a compensation (e.g., in the form of a mined coin and/or a service fee charged to the digital wallet of the user 140).

The user device 110, in one embodiment, may include at least one identifier 114, which may be implemented, for example, as operating system registry entries, cookies associated with the user interface application 112 and/or the wallet application 116, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user 140 with a particular user account, a particular digital wallet, and/or a particular profile.

In various implementations, the user 140 is able to input data and information into an input component (e.g., a keyboard) of the user device 110. For example, the user 140 may use the input component to interact with the UI application 112 (e.g., to retrieve content from third-party servers such as the merchant server 120, to provide inputs related to a goal to the service provider server 130, etc.).

Each of the user devices 180 and 190 may include similar hardware and software components as the user device 110 to enable their respective users to interact with the merchant server 120 and the service provider server 130 through the user devices 180 and 190. For example, the users of the user devices 110, 180, and 190 may use the respective devices to conduct electronic transactions (e.g., cryptocurrency transactions) through different user accounts of the service provider server 130 and/or through different digital wallets. Furthermore, each of the user devices 180 and 190 also includes a wallet application (e.g., the wallet applications 186 and 196, respectively), configured to perform cryptocurrency functionalities, in a similar manner as the wallet application 116.

The merchant server 120, in various embodiments, may be maintained by a business entity (or in some cases, by a partner of a business entity that processes transactions on behalf of business entity). Examples of business entities include merchants, resource information providers, utility providers, real estate management providers, social networking platforms, etc., which offer various items for viewing, accessing, and/or purchasing, and process payments for the purchases. As shown, the merchant server 120 may include a merchant database 124 for identifying available items, which may be made available to the user devices 110, 180, and 190 for viewing and purchase by the user.

The merchant server 120, in one embodiment, may include a marketplace application or server 122, which may be configured to provide information (e.g., displayable content) over the network 160 to the user interface application 112 of the user device 110. In one embodiment, the marketplace application 122 may include a web server that hosts a merchant website for the merchant. For example, the user 140 of the user device 110 may interact with the marketplace application 122 through the user interface application 112 over the network 160 to search and view various items available for access and/or purchase in the merchant database 124. The merchant server 120, in one embodiment, may be associated with at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.). In some embodiments, the merchant server 120 may be associated with a digital wallet for receiving funds, including cryptocurrency, from other digital wallets for purchasing items from the business entity.

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing for electronic transactions between different entities (e.g., among the users of the user devices 110, 180, and 190, between a user and one or more business entities (e.g., the business entity associated with the merchant server 120, etc.), or other types of payees. As such, the service provider server 130 may include a service application 138, which may be adapted to interact with the user devices 110, 180, and 190, and/or the merchant server 120 over the network 160 to facilitate the searching, selection, purchase, payment of items, and/or other services offered by the service provider server 130. In one example, the service provider server 130 may be provided by PayPal®, Inc., of San Jose, Calif., USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities (e.g., between two users, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various services provided by the service provider server 130 (e.g., such as the auxiliary cryptocurrency transaction services as disclosed herein). The interface server 134 may also include other electronic pages associated with the different services (e.g., electronic transaction services, etc.) offered by the service provider server 130. As a result, a user (e.g., the user 140, users of the user devices 180 and 190, or a merchant associated with the merchant server 120, etc.) may access a user account associated with the user and access various services offered by the service provider server 130, by generating HTTP requests directed at the service provider server 130. In some embodiments, the fragment module integration framework may be implemented within or in association with the interface server 134.

The service provider server 130, in one embodiment, may be configured to maintain one or more user accounts and merchant accounts in an account database 136, each of which may be associated with a profile and may include account information associated with one or more individual users (e.g., the user 140 associated with user device 110, users associated with the user devices 180 and 190) and merchants. The account information may include an identifier of a digital wallet associated with each user account of a user. In one implementation, a user may have credentials to authenticate or verify identity with the service provider server 130. Thus, the service provider server may store the credentials of the users in corresponding records of the account database 136 associated with the user accounts.

In various embodiments, the service provider server 130 includes a transaction module 132 that implements the transaction system as discussed herein. In particular, the transaction module 132 may conduct event-based auxiliary cryptocurrency transactions for the users (e.g., the user 140). Through the user interface provided via the interface server 134, the user 140 may provide inputs associated with event-based trigger configurations for the corresponding user account. For example, the inputs may specify a set of event parameters for detectable events. The set of event parameters may include a particular time of a day, a particular day of a week, a particular day of a month, etc. when the detectable event is a time event. The set of event parameters may include a transaction parameter associated with transactions using a particular account (e.g., a digital wallet of the user 140, etc.), such as a particular threshold amount, a particular time of day when the transaction is conducted, etc. In some embodiments, the transaction module 132 may enable the user (e.g., the user 140) to specify multiple events for conducting the auxiliary cryptocurrency transactions.

The inputs may also specify transaction parameters such as an identity of a recipient digital wallet, an amount for each auxiliary cryptocurrency transaction to be conducted, and other parameters. For example, if the user has a goal of purchasing a particular item, the user may provide, to a merchant (e.g., a digital wallet associated with the merchant), a portion of the cost of the particular item in each auxiliary cryptocurrency transaction. In another example, if the user has a goal of paying off a loan, the user may provide, to a digital wallet of a bank (or a loan company), a portion of the loan amount in each auxiliary cryptocurrency transaction. In yet another example, if the user has a saving goal, the user may provide, to a digital wallet associated with a saving account of the user, a small amount toward the saving goal in each auxiliary cryptocurrency transaction.

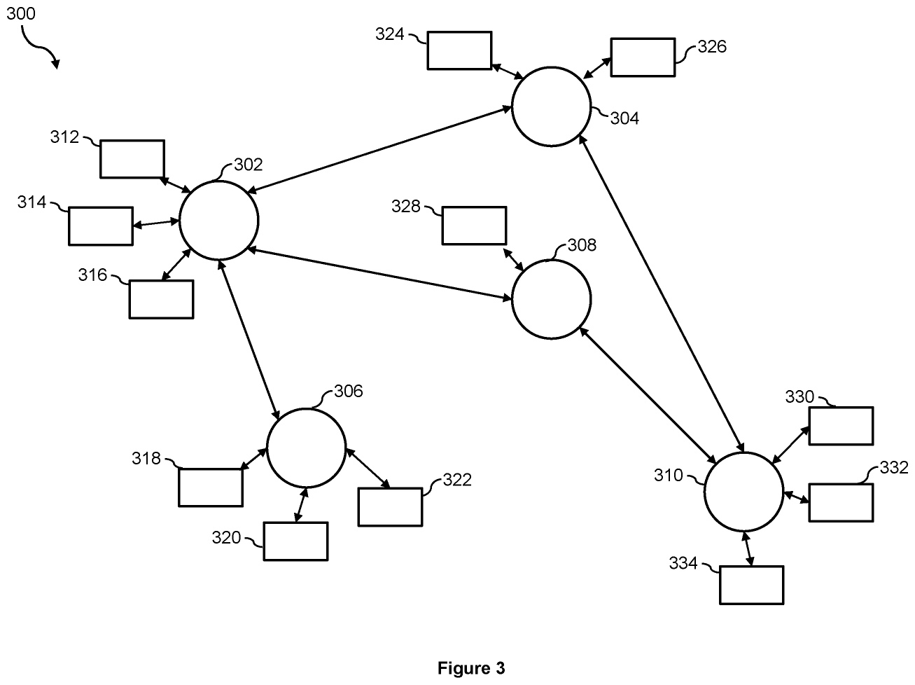

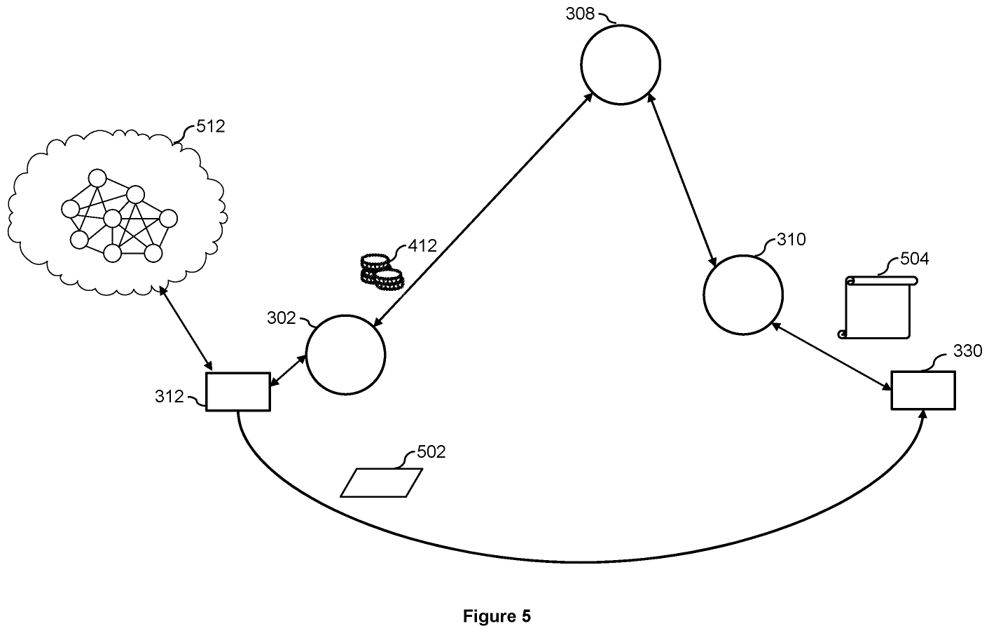

The transaction module 132 may store the event-based trigger configuration in association with the account of the user 140 in the account database 136. After the event-based trigger configuration is determined, the transaction module 132 may begin monitoring events associated with the user account. If an event that corresponds to the event-based trigger configuration is detected, the transaction system may conduct an auxiliary cryptocurrency transaction using a Layer 2 cryptocurrency computer network through the digital wallet of the user. The Layer 2 cryptocurrency computer network will be discussed in further detailed herein by reference to FIGS. 3 and 5.

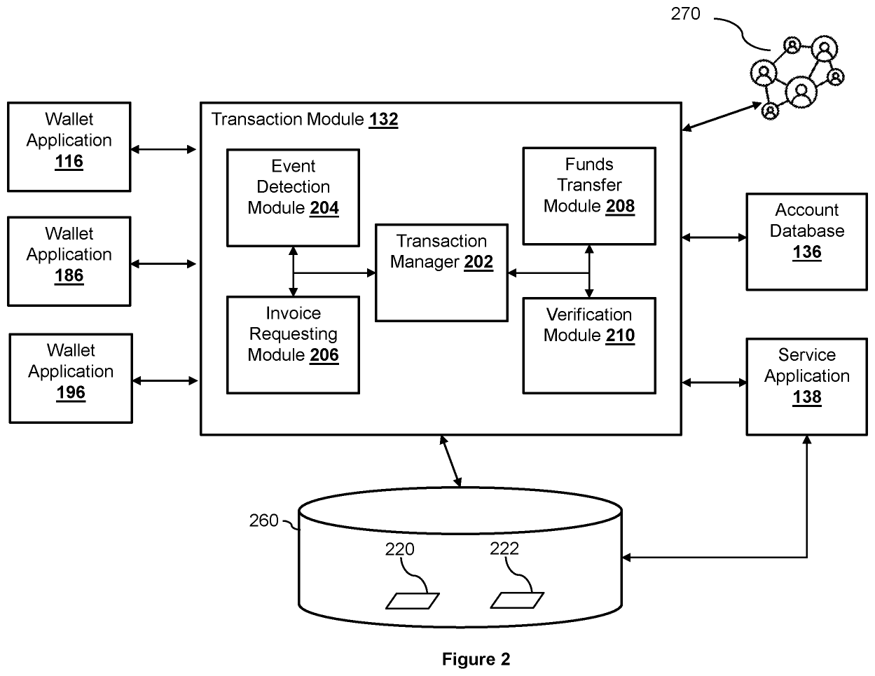

FIG. 2 illustrates a block diagram of the transaction module 132 according to an embodiment of the disclosure. The data access module 132 includes a transaction manager 202, an event detection module 204, an invoice requesting module 206, a funds transfer module 208, and a verification module 210. In some embodiments, the transaction module 132 may be communicatively coupled to the account database 136 and the service application 138. As discussed herein, the service application 138 may be configured to process transactions for users of the service provider server 130. Thus, the event detection module 204 may monitor transactions conducted through a user account of the user (e.g., the user 140) and determine whether the transactions conducted correspond to the event-based trigger configuration. The event detection module 204 of some embodiments may also monitor other activities, such as transactions conducted using the wallet applications 116, 186, and 196 and determine whether the transactions conducted using the wallet applications 116, 186, and 196 correspond the event-based trigger configuration of any one of the accounts with the service provider server 130.

In some embodiments, the event detection module 204 may also monitor other activities to determine whether an event corresponds to the event-based trigger configuration of an account of a user has occurred. For example, the event detection module 204 may monitor a current time. The event detection module 204 may determine whether a current time corresponds to any time parameters specified in the event-based trigger configuration of an account (e.g., a time of a day, a day of a week, a day of a month, etc.).

Upon detection of an event (e.g., a transaction, a current time) that corresponds to the event-based trigger configuration of an account, the transaction manager 202 may facilitate an auxiliary cryptocurrency transaction using a Layer 2 cryptocurrency computer network 270. For example, the transaction manager 202 may determine parameters of the auxiliary cryptocurrency transaction, such as a recipient digital wallet, an amount, etc. based on the event-based trigger configuration associated with the account. The transaction manager 202 may then use the invoice requesting module 206 to generate a request for invoice based on the parameters of the auxiliary cryptocurrency (e.g., an amount, a recipient digital wallet, etc.). The transaction manager 202 may transmit the request for invoice to the recipient digital wallet.

A wallet application associated with the recipient digital wallet (e.g., the wallet application 186) may receive the request for invoice. Upon receiving the request for invoice, the wallet application 186 may generate a digital invoice that specifies the sender digital wallet (e.g., the digital wallet of the user 140), the recipient digital wallet (e.g., the digital wallet associated with the wallet application 186), the amount, and a hashed value 220 generated based on performing a hash operation on pre-image data (which can be arbitrary data). The wallet application 186 may transmit the digital invoice to the service provider server 130 and/or the digital wallet 116.

After receiving the digital invoice from the wallet application 186, the transaction manager 202 may store the hashed value 220 with other hashed values for other auxiliary cryptocurrency transactions (e.g., hashed value 222) in a data storage 260. The transaction manager 202 may also use the funds transfer module 208 to cause the invoice to be funded. For example, the funds transfer manager 208 may identify a first computer node within the Layer 2 cryptocurrency computer network 270 that is associated with the digital wallet of the user 140. The funds transfer manager 208 may also identify a second computer node within the Layer 2 cryptocurrency computer network 270 that is associated with the recipient digital wallet (e.g., the digital wallet associated with the wallet application 186). The funds transfer manager 208 may then traverse the Layer 2 cryptocurrency computer network 270 to determine a route between the first computer node and the second computer node. In some embodiments, if multiple routes are determined between the first computer node and the second computer node, the funds transfer manager 208 may determine one route for funding the invoice based on a set of criteria (e.g., the shortest route, the lowest service fees charged by computer nodes along the route, etc.).

The funds transfer module 208 may then cause the first computer node to fund the invoice using funds from the digital wallet of the user 140. In some embodiments, the first computer node may fund the digital invoice by creating, for the invoice, a hash time lock contract (HTLC) between the first computer node and the next computer node in the route. The hash time lock contract specifies a condition for release of funds from the first computer node to the next computer node upon a condition being met, which may be the receipt of the secret corresponding to the hashed value included in the invoice.

If the first computer node is directly connected to the second computer node via a payment channel established between the first and second computer nodes, the first computer node may transmit the HTLC to the second computer node. However, if the first computer node is not directly connected to the second computer node in the Layer 2 cryptocurrency computer network 270, the first computer node may transmit the HTLC to another computer node (e.g., an intermediate computer node such as a third computer node) along the route with which the first computer node is directed connected (e.g., a payment channel is established between the first computer node and the third computer node). The third computer node may similarly create an HTLC between the third computer node and the next computer node (e.g., another intermediate computer node such as a fourth computer node) along the route. The intermediate computer nodes may continue to create HTLCs with the next computer node until an HTLC is created between an intermediate computer node and the second computer node associated with the recipient digital wallet.

Upon receiving the HTLC, the second computer node may forward the HTLC to the recipient digital wallet. The wallet application 186 associated with the recipient digital wallet may, based on the HTLC, send a confirmation back to the second computer node. The confirmation may include the secret used by the wallet application 186 to generate the hashed value for the invoice. The second computer node may then fulfill its obligation according to the HTLC by transmitting the confirmation including the secret to the computer node (e.g., the fourth computer node) with which the HTLC was created. The fourth computer node may in turn transmit the confirmation including the pre-image data received from the second computer node to another computer node with which the HTLC was created (e.g., the third computer node) to fulfill its obligation according to the HTLC. In this manner, the confirmation is transmitted by the computer nodes along the route in reverse order from the second computer node to the first computer node until it reaches the first computer node. The first computer node may transmit the confirmation to the transaction module 132 and/or the wallet application 116.

After receiving the confirmation, the verification module 210 may verify the confirmation by performing a hash operation on the secret to determine whether the output from the hash operation corresponds to the hashed value 220 from the digital invoice. If it is determined that the value generated by performing a hash operation on the pre-image data corresponds to the hashed value 220 included in the invoice, the transaction manager 202 may authorize the first computer node to release the funds to the second computer node. The first computer node may release the funds by transferring the funds to the computer node from which the first computer node receives the confirmation (e.g., the third computer node) via a payment channel created between the first computer node and the third computer node. The release of the funds by the first computer node to the third computer node fulfills its obligation according to the HTLC between the first computer node and the third computer node. Based on receiving the funds from the first computer node, the third computer node may in turn release funds by transferring the funds to the computer node from which the third computer node receives the confirmation (e.g., the fourth computer node) via a payment channel created between the third computer node and the fourth computer node to fulfill its obligation according to the HTLC between the third computer node and the fourth computer node. Upon receiving the funds from the third computer node, the fourth computer node may release the funds by transferring the funds to the second computer node from which the fourth computer node receives the confirmation via a payment channel created between the fourth computer node and the second computer node to fulfill its obligation according to the HTLC between the fourth computer node and the second computer node. This way, funds are transferred by the digital wallet of the user 140 to the recipient digital wallet without using the Layer 1 cryptocurrency computer network.

FIG. 3 illustrates an exemplary Layer 2 cryptocurrency computer network 300 according to various embodiments of the disclosure. In some embodiments, the network 300 is only a portion of a larger Layer 2 cryptocurrency computer network. As shown, the Layer 2 cryptocurrency computer network 300 includes computer nodes 302-310. Some of the computer nodes 302-310 are connected with each other within the Layer 2 cryptocurrency computer network 300. As discussed herein, two computer nodes may connect with each other within the Layer 2 cryptocurrency computer network 300 by establishing a payment channel. In this example and as indicated by the connections in the Layer 2 cryptocurrency computer network 300, a payment channel has been established between the computer nodes 302 and 304, another payment channel has been established between the computer nodes 302 and 306, another payment channel has been established between the computer nodes 302 and 308, another payment channel has been established between the computer nodes 304 and 310, and another payment channel has been established between the computer nodes 308 and 310. By establishing a payment channel between two computer nodes within the Layer 2 cryptocurrency computer network, the two computer nodes can facilitate cryptocurrency transactions (e.g., transferring of funds in cryptocurrency) without using any resources from the Layer 1 cryptocurrency computer network.

Each computer node within the Layer 2 cryptocurrency computer network 300 may be associated with one or more digital wallets. For example, the computer node 302 is associated with digital wallets 312-316, the computer node 304 is associated with digital wallets 324 and 326, the computer node 306 is associated with digital wallets 318-322, the computer node 308 is associated with a digital wallet 328, and the computer node 310 is associated with digital wallets 330-334.

When a digital wallet is associated with a computer node within the Layer 2 cryptocurrency computer network 300, the digital wallet may use that associated computer node to perform a cryptocurrency transaction for the digital wallet through the Layer 2 cryptocurrency computer network 300, without requiring any resources from the Layer 1 cryptocurrency computer network. In this example, the digital wallet 312 may be the digital wallet of the user, associated with the wallet application 116, and the digital wallet 330 may be the recipient digital wallet, associated with the wallet application 186. When the funds transfer module 208 determines to transmit funds for a digital wallet (e.g., the digital wallet 312 of the user 140), the funds transfer module 208 may first determine whether the digital wallet 312 and a recipient digital wallet for which funds are intended (e.g., the digital wallet 330) are associated with one or more computer nodes that are connected with each other in the Layer 2 cryptocurrency computer network 300. For example, the funds transfer module 208 may determine that the digital wallet 312 is associated with the computer node 302, and the digital wallet 330 is associated with the computer node 310 within the Layer 2 cryptocurrency computer network 300.

The funds transfer module 208 may further determine that the computer nodes 302 and 310 are connected via the computer node 308 or the computer node 304. Thus, the funds transfer module 208 may determine multiple routes for facilitating the transfer of funds from the digital wallet 312 to the digital wallet 330. In some embodiments, when multiple routes are determined, the funds transfer module 208 may use a set of criteria (e.g., the least number of computer nodes in the route, the smallest service fee, etc.) for selecting the route for the cryptocurrency transaction.

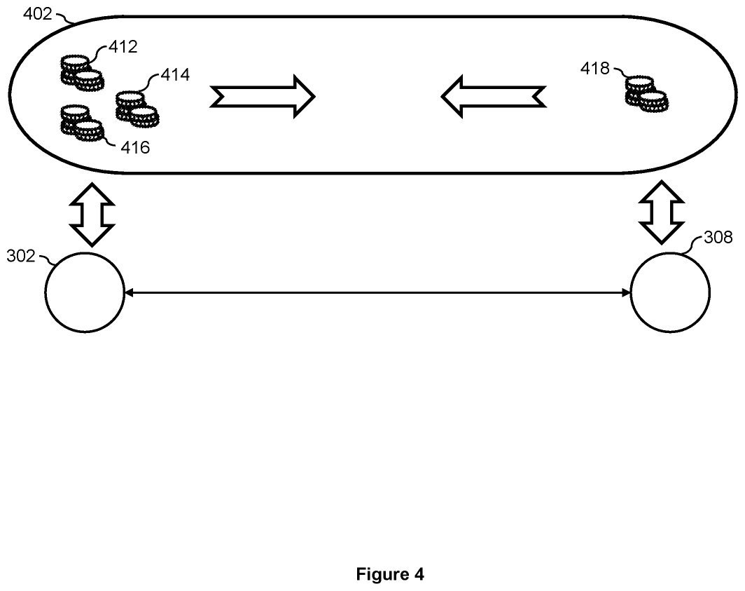

As discussed herein, two computer nodes may be connected within the Layer 2 cryptocurrency computer network 300 based on a payment channel established between the computer nodes. FIG. 4 illustrates an example payment channel 402 established between the computer nodes 302 and 308 according to various embodiments of the disclosure. In some embodiments, the computer nodes 302 and 308 may establish the payment channel 402 based on an open payment agreement (a multi-signature agreement) that is recorded in the Layer 1 cryptocurrency computer network. The open payment agreement requires at least one of the two participating computer nodes 302 and 308 to contribute funds (in cryptocurrency) to the payment channel 402 to prove its liquidity for transacting within the Layer 2 cryptocurrency computer network. In this example, the computer node 302 may contribute funds 412, 414, and 416 to the payment channel 402 and the computer node 308 may contribute fund 418 to the payment channel 402. Once the funds are contributed to the payment channel 402, the funds are no longer available for use in any transactions within the Layer 1 cryptocurrency computer network until the payment channel 402 is terminated.

The open payment agreement may also stipulate an allocation of the funds in the payment channel 402. Initially, the open payment agreement may stipulate that the funds are allocated between the computer nodes 302 and 308 according to the amounts contributed by the respective computer node. Thus, the funds 412, 414, and 416 are initially allocated to the computer node 302, and the funds 418 is initially allocated to the computer node 308. Once the payment channel 402 is established, the computer nodes 302 and 308 may perform cryptocurrency transactions with each other via the Layer 2 cryptocurrency computer network 300 based on their liquidities within the payment channel 402, without requiring any resources from the Layer 1 cryptocurrency computer network. When a cryptocurrency transaction occurs between the computer nodes 302 and 308, the computer nodes 302 and 308 may amend the open payment agreement to stipulate a new allocation of funds in the payment channel 402 between the computer nodes 302 and 308. For example, if the funds 412 are transferred from the computer node 302 to the computer node 308, the new allocation of funds may specify that the funds 412 are now allocated to the computer node 308, without recording any cryptocurrency transactions in a ledger of the Layer 1 cryptocurrency computer network. The computer nodes 302 and 308 may continue to perform cryptocurrency transactions via the Layer 2 cryptocurrency computer network by modifying the allocation of funds within the payment channel 402. When the computer nodes 302 and 308 terminate the payment channel 402, the computer nodes 302 and 308 may record any transfer of funds in cryptocurrency in the Layer 1 cryptocurrency computer network based on the latest modified fund allocation.

FIG. 5 illustrates an example auxiliary cryptocurrency transaction according to various embodiments of the disclosure. In some embodiments, the event detection module 204 may monitor activities associated with a digital wallet (e.g., the digital wallet 312) based on the event-based trigger configuration associated with the user 140. For example, the event-based trigger configuration may specify an event associated with a cryptocurrency transaction within a Layer 1 cryptocurrency computer network 512. Thus, the event detection module 204 may monitor new transaction records being added to the ledger associated with the Layer 1 cryptocurrency computer network 512. When the event detection module 204 detects a cryptocurrency transaction conducted through the digital wallet 312 via the Layer 1 cryptocurrency computer network, the transaction manager 202 may determine an auxiliary cryptocurrency transaction based on the detected transaction and the event-based trigger configuration of the user 140. The auxiliary cryptocurrency transaction may involve a transfer of funds from the digital wallet 312 to a recipient digital wallet (e.g., the digital wallet 330).

The invoice requesting module 206 may generate a request for invoice 502 based on the auxiliary cryptocurrency transaction, and may transmit the request for invoice 502 to the digital wallet 330. Based on the request for invoice 502, an application (e.g., the wallet application 186) associated with the digital wallet 330 may generate an invoice 504, and may transmit the invoice 504 to the digital wallet 312. The invoice 504 may include a hashed value that is generated by the wallet application 186 associated with the digital wallet 330 by performing a hash operation on pre-image data.

After receiving the invoice 504, the funds transfer module 208 may then cause the computer node 302 to fund the invoice 504. In some embodiments, the computer node 302 may fund the invoice 504 by creating a hash time lock contract (HTLC) with the next computer node along a route between the computer node 302 and the computer node 310 associated with the digital wallet 330. In this example, the transaction manager 202 may select the route that includes the computer nodes 302, 308, and 310. Thus, the computer node 302 may create an HTLC with the computer node 308. The HTLC is an agreement between the computer nodes 302 and 308, and specifies obligations to be fulfilled by both computer nodes 302 and 308. For example, the HTLC may specify that the computer node 308 provide a value (e.g., a secret) used by the computer node 310 to generate the hashed value included in the invoice 504. In exchange, the computer node 302 may transfer funds in the amount associated with the auxiliary cryptocurrency transaction to the computer node 308.

In some embodiments, the computer node 308 may also create another HTLC with the next computer node in the route. In this example, the next computer node is the computer node 310 associated with the recipient digital wallet 330. The HTLC between the computer nodes 308 and 310 may be similar to the HTLC between the computer nodes 302 and 308 in that it also specifies similar obligations from the computer nodes 308 and 310. Specifically, the HTLC may specify that the computer node 310 should provide to the computer node 308 the secret used to generate the hashed value included in the invoice 504. In exchange, the computer node 308 would provide the funds to the computer node 310.

Based on the HTLC, the computer node 310 may provide the secret used to generate the hashed value in the invoice 504 to the computer node 308, to fulfill its obligation according to the HTLC between the computer nodes 308 and 310. The computer node 308 may, in turn, relay the secret to the computer node 302 to fulfill its obligation in the HTLC between the computer nodes 302 and 308. The verification module 210 may obtain the secret from the computer node 302, and may verify the secret. For example, the verification module 210 may perform a hash operation on the secret to generate an output. The verification module 210 may compare the output against the hashed value included in the invoice 504. The verification module 210 may determine that the secret received from the computer node 308 is verified if the output matches the hashed value included in the invoice 504, and may instruct the computer node 302 to release the funds. If the output is not verified, the verification module 210 may instruct the computer node 302 to halt releasing the funds.

Based on the instructions from the verification module 210, the computer node 302 may release funds to the computer node 308 via the payment channel 402 using techniques described herein by reference to FIG. 4. The computer node 308 may, in turn, release funds to the computer node 310 via a payment channel established between the computer nodes 308 and 310 to complete the auxiliary cryptocurrency transaction.

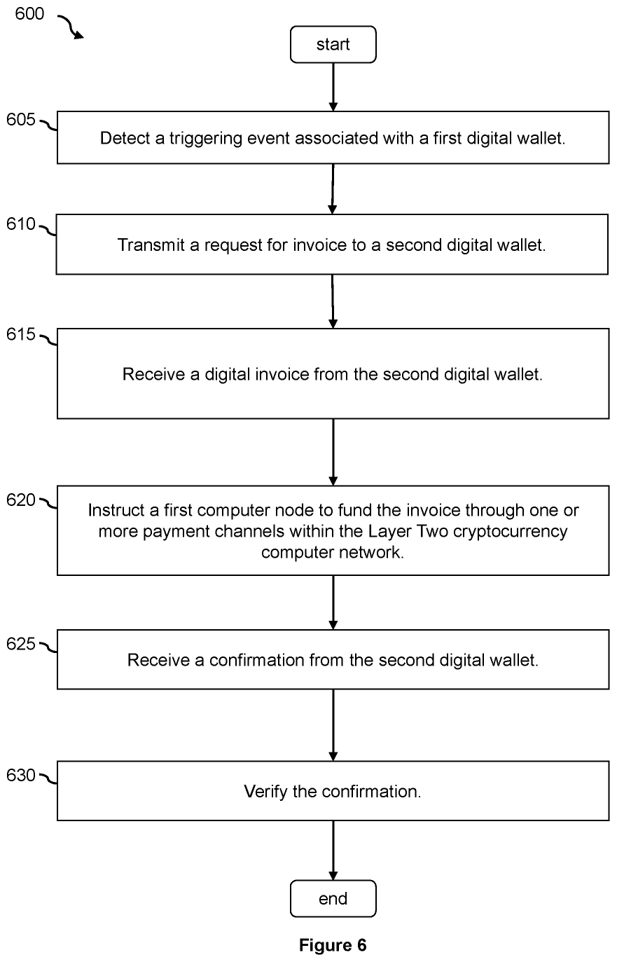

FIG. 6 illustrates a process 600 for facilitating an auxiliary cryptocurrency transaction via the Layer 2 cryptocurrency computer network based on a trigger event according to various embodiments of the disclosure. In some embodiments, at least a portion of the process 600 may be performed by the transaction module 132. The process 600 may begin by detecting (at step 605) a triggering event associated with a first digital wallet. For example, the event detection module 204 may monitor activities associated with the digital wallet 312. The event detection module 204 may detect an event corresponding to the event-based trigger configuration of the user 140, such as a cryptocurrency transaction conducted via the Layer 1 cryptocurrency computer network. Based on the detected event and the event-based trigger configuration of the user 140, the transaction manager 202 may determine an auxiliary cryptocurrency transaction. The auxiliary cryptocurrency transaction may include a fund transfer transaction from the digital wallet 312 of the user 140 to a recipient digital wallet (e.g., the digital wallet 330).

The process 600 then transmits (at step 610) a request for invoice to a second digital wallet. For example, the invoice requesting module 206 may transmit a request for invoice 502 to the digital wallet 330. Based on the request for invoice 502, an application associated with the digital wallet 330 may generate an invoice (e.g., the invoice 504) that includes a hashed value.

The process 600 receives (at step 615) a digital invoice from the second digital wallet and instructs (at step 620) a first computer node to fund the invoice through one or more payment channels within the Layer 2 cryptocurrency computer network. For example, the transaction module 132 may receive the invoice 504 from the digital wallet 330. The funds transfer module 208 may instruct the computer node 302 to fund the invoice 504 through the Layer 2 cryptocurrency computer network 300.

The process 600 then receives (at step 625) a confirmation from the second digital wallet and verifies (at step 630) the confirmation. For example, via the computer node 302, the verification module 210 may receive a confirmation (including the pre-image data) from the computer node 330 via the Layer 2 cryptocurrency computer network. The verification module 210 may verify the pre-image data by performing a hash operation on the pre-image data and compare the output of the hash operation against the hashed value included in the digital invoice 504. If the pre-image data is verified, the transaction manager 202 may instruct the computer node 302 to release the funds based on the invoice 504.

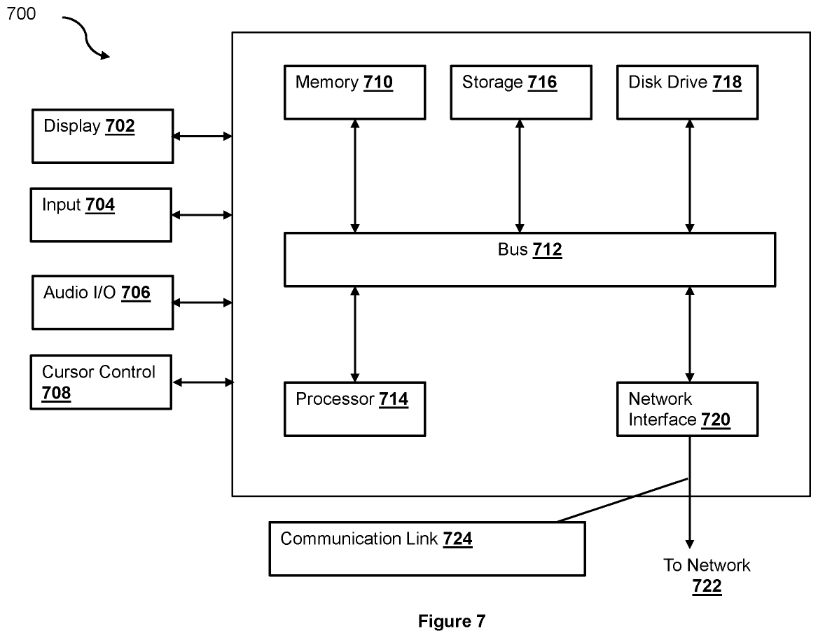

FIG. 7 is a block diagram of a computer system 700 suitable for implementing one or more embodiments of the present disclosure, including the service provider server 130, the merchant server 120, and the user devices 110, 180, and 190. In various implementations, each of the devices 110, 180, and 190 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices/servers 110, 120, 130, 180, and 190 may be implemented as the computer system 700 in a manner as follows.

The computer system 700 includes a bus 712 or other communication mechanism for communicating information data, signals, and information between various components of the computer system 700. The components include an input/output (I/O) component 704 that processes a user (i.e., sender, recipient, service provider) action, such as selecting keys from a keypad/keyboard, selecting one or more buttons or links, etc., and sends a corresponding signal to the bus 712. The I/O component 804 may also include an output component, such as a display 702 and a cursor control 708 (such as a keyboard, keypad, mouse, etc.). The display 702 may be configured to present a login page for logging into a user account or a checkout page for purchasing an item from a merchant. An optional audio input/output component 706 may also be included to allow a user to use voice for inputting information by converting audio signals. The audio I/O component 706 may allow the user to hear audio. A transceiver or network interface 820 transmits and receives signals between the computer system 700 and other devices, such as another user device, a merchant server, or a service provider server via a network 722, such as network 160 of FIG. 1. In one embodiment, the transmission is wireless, although other transmission mediums and methods may also be suitable. A processor 714, which can be a micro-controller, digital signal processor (DSP), or other processing component, processes these various signals, such as for display on the computer system 700 or transmission to other devices via a communication link 724. The processor 814 may also control transmission of information, such as cookies or IP addresses, to other devices.

The components of the computer system 700 also include a system memory component 710 (e.g., RAM), a static storage component 716 (e.g., ROM), and/or a disk drive 718 (e.g., a solid-state drive, a hard drive). The computer system 700 performs specific operations by the processor 714 and other components by executing one or more sequences of instructions contained in the system memory component 710. For example, the processor 714 can perform the event-based triggering of auxiliary cryptocurrency transactions functionalities described herein according to the process 600.

Logic may be encoded in a computer readable medium, which may refer to any medium that participates in providing instructions to the processor 714 for execution. Such a medium may take many forms, including but not limited to, non-volatile media, volatile media, and transmission media. In various implementations, non-volatile media includes optical or magnetic disks, volatile media includes dynamic memory, such as the system memory component 710, and transmission media includes coaxial cables, copper wire, and fiber optics, including wires that comprise the bus 712. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 700. In various other embodiments of the present disclosure, a plurality of computer systems 700 coupled by the communication link 724 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
detecting a triggering event associated with a first digital wallet;
in response to detecting the triggering event, transmitting a request for invoice to a second digital wallet corresponding to a receiving entity, wherein the request for invoice indicates a cryptocurrency amount to be transmitted from the first digital wallet to the second digital wallet, wherein the cryptocurrency amount is in a cryptocurrency associated with a Layer 1 cryptocurrency computer network, and wherein the request for invoice causes the second digital wallet to generate a digital invoice associated with the cryptocurrency amount;
receiving, from the second digital wallet, the digital invoice; and
without recording a transaction associated with the digital invoice in a public ledger associated with the cryptocurrency, instructing a first computer node to fund the digital invoice in a Layer 2 cryptocurrency computer network, wherein the instructing causes the first computer node to transfer funds in the cryptocurrency amount to a second computer node via one or more payment channels within the Layer 2 cryptocurrency computer network.

2. The system of claim 1, wherein the digital invoice comprises a hashed value, and wherein the operations further comprise:
receiving a confirmation of receiving the funds from the second digital wallet, wherein the confirmation comprises a secret; and
verifying the confirmation based on (i) hashing the secret and (ii) comparing the hashed secret against the hashed value.

3. The system of claim 1, wherein the triggering event comprises a cryptocurrency transaction conducted via the Layer 1 cryptocurrency computer network.

4. The system of claim 3, wherein the cryptocurrency amount is first cryptocurrency amount, and wherein the operations further comprise:
determining a second cryptocurrency amount associated with the cryptocurrency transaction; and
determining the first cryptocurrency amount based on the second cryptocurrency amount.

5. The system of claim 3, wherein the cryptocurrency transaction was conducted through the first digital wallet.

6. The system of claim 3, wherein the cryptocurrency transaction was conducted through a third digital wallet linked to the first digital wallet.

7. The system of claim 6, wherein the operations further comprise:
in response to detecting the cryptocurrency transaction conducted through the third digital wallet, determining that the third digital wallet is incompatible with the Layer 2 cryptocurrency computer network;
generating the first digital wallet that is compatible with the Layer 2 cryptocurrency computer network based on a set of wallet configurations associated with the third digital wallet;
funding the first digital wallet based on the third digital wallet; and
linking the first digital wallet to the third digital wallet.

8. A method, comprising:
detecting, by one or more hardware processors, a triggering event associated with a first digital wallet;
in response to detecting the triggering event, transmitting, by the one or more hardware processors, a request for invoice to a second digital wallet corresponding to a receiving entity, wherein the request for invoice indicates a cryptocurrency amount to be transmitted from the first digital wallet to the second digital wallet, wherein the cryptocurrency amount is in a cryptocurrency associated with a Layer 1 cryptocurrency computer network, and wherein the request for invoice causes the second digital wallet to generate a digital invoice associated with the cryptocurrency amount;
receiving, by the one or more hardware processors and from the second digital wallet, the digital invoice comprising a hashed value; and
without recording a transaction associated with the digital invoice in a public ledger associated with the cryptocurrency, instructing a first computer node to fund the digital invoice in a Layer 2 cryptocurrency computer network, wherein the instructing causes the first computer node to transmit funds in the cryptocurrency amount to a second computer node via one or more payment channels within the Layer 2 cryptocurrency computer network.

9. The method of claim 8, wherein the triggering event comprises a fiat currency transaction.

10. The method of claim 8, wherein the cryptocurrency amount is smaller than a threshold amount transactable through the Layer 1 cryptocurrency payment network.

11. The method of claim 8, further comprising:
determining that the second digital wallet is associated with a second computer node within the Layer 2 cryptocurrency computer network; and
identifying a route comprising a plurality of computer nodes within the Layer 2 cryptocurrency computer network that connects the first computer node to the second computer node.

12. The method of claim 11, further comprising:
determining, among the plurality of computer nodes, a third computer node that is directly connected to the first computer node; and
creating a hash time lock contract between the first computer node and the third computer node based on a payment channel established between the first computer node and the third computer node, wherein the hash time lock contract causes the first computer node to transfer the funds to the third computer node via the payment channel in exchange for a secret corresponding to the hashed value.

13. The method of claim 12, further comprising:
verifying the secret received from the second digital wallet; and
in response to verifying the secret, causing the first computer node to transfer the funds to the third computer node.

14. The method of claim 8, wherein the transaction is an off-chain transaction.

15. A non-transitory machine-readable medium having stored thereon machine-readable instructions executable to cause a machine to perform operations comprising:
detecting a first cryptocurrency transaction conducted through a first digital wallet via a Layer 1 cryptocurrency computer network;
in response to detecting the first cryptocurrency transaction, determining an second cryptocurrency transaction for the digital wallet, wherein the second cryptocurrency transaction comprises transferring funds from the first digital wallet to a second digital wallet via a Layer 2 cryptocurrency computer network; and
performing the second cryptocurrency transaction by:
transmitting a request for invoice to the second digital wallet, wherein the request for invoice causes the second digital wallet to generate a digital invoice;
receiving, from the second digital wallet, the digital invoice; and
without recording the second cryptocurrency transaction in a public ledger associated with the cryptocurrency, instructing a first computer node to fund the digital invoice in the Layer 2 cryptocurrency computer network, wherein the instructing causes the first computer node to transfer the funds to a second computer node via one or more payment channels within the Layer 2 cryptocurrency computer network.

16. The non-transitory machine-readable medium of claim 15, wherein the operations further comprise:
determining a first cryptocurrency amount associated with the first cryptocurrency transaction; and
determining a second cryptocurrency amount for the second cryptocurrency transaction based on the first cryptocurrency amount.

17. The non-transitory machine-readable medium of claim 16, wherein the second cryptocurrency amount is a portion of the first cryptocurrency amount.

18. The non-transitory machine-readable medium of claim 15, wherein the operations further comprise:
determining that the second digital wallet is associated with a second computer node within the Layer 2 cryptocurrency computer network; and
identifying a route comprising a plurality of computer nodes within the Layer 2 cryptocurrency computer network that connects the first computer node to the second computer node.

19. The non-transitory machine-readable medium of claim 18, wherein the operations further comprise:
determining, among the plurality of computer nodes, a third computer node that is directly connected to the first computer node; and
creating a hash time lock contract between the first computer node and the third computer node based on a payment channel established between the first computer node and the third computer node, wherein the hash time lock contract causes the first computer node to transfer the funds to the third computer node via the payment channel in exchange for a secret corresponding to the hashed value.

20. The non-transitory machine-readable medium of claim 19, wherein the operations further comprise:
verifying the secret received from the second digital wallet; and
in response to verifying the secret, causing the first computer node to transfer the funds to the third computer node.
